(19) United States
(12) Patent Application Publication
(10) Pub. No.: US 2025/0301972 A1
(43) Pub. Date: Oct. 2, 2025

(54) METHOD AND APPARATUS FOR TIMBER HARVESTING AND SUPPLY CHAIN MANAGEMENT

(71) Applicant: Lim Geomatics, Ottawa (CA)

(72) Inventors: Kevin LIM, Ottawa (CA); Matthieu RUMEAU, Montreal (CA)

(21) Appl. No.: 18/619,956

(22) Filed: Mar. 28, 2024

(51) Int. Cl. A01G 23/083; A01G 23/099

(52) U.S. Cl. CPC A01G 23/083; A01G 23/099

(57) ABSTRACT

A method and system for timber harvesting and supply chain management are disclosed, focusing on supporting forestry and timber harvesting productivity and utilization monitoring the timber harvesting supply chain. The method involves obtaining performance data from timber handling machines and determining the volume of timber processed by analyzing machine paths, work operations, and the working area, coupled with regional timber volume data. The system generates worklogs, providing useful insights into timber handling activities, which can be used to direct further timber harvesting actions. The present invention offers improvements over existing methods by offering a tool for data driven decision-making, thus optimizing operational workflows and resource management.

### CROSS-REFERENCE TO RELATED APPLICATIONS

This is the first application filed for this invention.

### FIELD OF THE INVENTION

The present invention pertains in general to the field of forestry and whole-tree timber harvesting supply chain, and in particular to a method and apparatus for timber harvesting productivity and utilization monitoring across all stages of the timber harvesting supply chain, from tree-to-truck including directing harvesting and subsequent operations.

### BACKGROUND

The forestry industry, with particular regard to timber harvesting (logging) is subject to rising costs and operational pressures which necessitate improvements in efficiency and productivity. This can be particularly challenging because timber harvesting involves multiple operations by different machines, many of which must be located in a remote area. Such operations (also referred to as handling) can include on-site operations such as felling, on-site processing, local transportation and loading, as well as long-range transportation and mill processing. The coordination of such diverse operations presents an ongoing operational challenge.

Forestry telematics solutions have been proposed by which on-site forestry machine operational data can be captured and sent to end users for analysis and decision making, or else by which machine operators can be provided with information to guide their actions. However, to date the amount of operational data, and the information obtained from such data, has been limited. This has in turn limited the performance and usefulness of such solutions.

Therefore, there is a need for a method and apparatus for supporting forestry in general and timber harvesting in particular that overcomes one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide a method and apparatus for supporting forestry and timber harvesting productivity and utilization monitoring across all stages of the whole-tree timber harvesting supply chain, from tree-to-truck. According to various embodiments, timber handling machine performance data is obtained from multiple points in the timber harvesting supply chain, and the data is processed to provide useful and actionable information. Such information can then be used to direct further timber harvesting actions. Embodiments provide improved supply chain visibility as well as equipment productivity and utilization monitoring across multiple stages of the timber harvesting supply chain, from tree-to-truck. By doing so, embodiments may provide a toolset for making data driven decisions and resulting performance improvements.

In accordance with embodiments of the present disclosure, a method for timber harvesting management is provided. The method includes obtaining information from a timber handling machine and determining the volume of timber handled by the timber handling machine during a specified period. The determining includes determining a path taken or an area occupied by the machine during the specified period, determining work operations taken by the machine during the specified period, determining a working area surrounding the path taken or the area occupied based at least in part on characteristics of the machine, and processing the working area together with data indicative of estimated volumes of timber for a region including the working area to determine the volume of timber handled. The method further comprises generating and providing a worklog based on the obtained information, the worklog indicating the volume of timber handled.

In some embodiments, determining the working area includes resolving an overlap between the working area and another working area determined for the machine or for another machine having a same role as the machine, the resolving including: determining an area in which the working area and the other working area overlap; keeping the area as part of one of: the working area and the other working area; and deleting the area from the other of: the working area and the other working area.

In some embodiments, determining the working area includes buffering the path taken by the machine to generate an area surrounding the path, the area extending from the path to a distance which is based at least in part on a reach of the timber handling machine.

In some embodiments, the method further includes determining an active time of the machine, the active time indicating a time during which the engine is either turned on or the engine is turned off after being turned on, but turned on again within a predetermined threshold amount of time.

In some embodiments, the method further includes determining a productivity based on a ratio of the volume of timber to the active time, the worklog indicating the determined productivity.

In some embodiments, the estimated volumes of timber for the region are based at least in part on prior timber harvesting activities performed in the region by one or more of: the timber handling machine; one or more other timber handling machines having a same role as the timber handling machine.

In some embodiments, the method includes determining a role of the machine based on its location.

In some embodiments, the method includes providing a plurality of worklogs including the worklog to a computerized predictor, and using the predictor to predict aspects of further timber harvesting operations based on the plurality of worklogs.

In some embodiments, the timber handling machine is a feller, a primary transporter, a processor or a loader.

In accordance with other embodiments of the present disclosure, there is provided a method for timber harvesting management. The method includes, for each one of a plurality of stages in a timber harvesting operation supply chain, determining an evolution, over time, of volume of timber handled at said one of the plurality of stages, and presenting, via a user interface, a combined indication of the evolutions, over time, of said volumes of timber handled at each said one of the plurality of stages.

In some embodiments, the evolution of volume of timber handled is determined based on a set of worklogs, at least some of the worklogs being determined according to the method as discussed in the foregoing.

In some embodiments, volume of timber handled at a particular stage of the plurality of stages is determined based on a spatial analysis. The spatial analysis includes determining one or more working areas each surrounding a path taken or an area occupied by a corresponding timber handling machine and processing each one of the one or more working areas together with data indicative of estimated volumes of timber for a region including said one of the one or more working areas to determine the volume of timber handled at the particular stage.

In some embodiments, volume of timber handled at another stage of the plurality of stages is determined based on volume or weight information reported directly by timber handling machinery performing said other stage or by timber handling machinery receiving timber from said other stage.

In some embodiments, the plurality of stages includes two or more of a felling stage, a primary transportation stage, a processing stage, and a loading stage.

In some embodiments, the method further includes automatically comparing two or more of the determined evolutions of volume of timber handled and presenting a result of said comparison.

In accordance with other embodiments of the present disclosure, there is provided a system for timber harvesting management. The system includes a data acquisition module configured to obtain information from a timber handling machine, and a volume determination module configured to determine a volume of timber handled by the timber handling machine during a specified period. Specifically, the determining includes determining a path taken or an area occupied by the machine during a specified period, determining work operations taken by the machine during the specified period, determining a working area surrounding the path taken or the area occupied, based at least in part on characteristics of the machine and resolving overlaps between working areas, and processing the working area together with data indicative of estimated volumes of timber for a region including the working area, to determine the volume of timber handled. The system further comprises a worklog generation module configured to generate a worklog based on the obtained information, and a user interface configured to indicate the volume of timber handled.

In accordance with other embodiments of the present disclosure, there is further provided a system for timber harvesting management. The system includes a worklog generation module configured to determine, for each one of a plurality of stages in a timber harvesting operation supply chain, an evolution, over time, of volume of timber handled at said one of the plurality of stages; and a user interface configured to present a combined indication of the evolutions, over time, of said volumes of timber handled at each said one of the plurality of stages.

### BRIEF DESCRIPTION OF THE FIGURES

Further features and advantages of the present disclosure will become apparent from the following detailed description, taken in combination with the appended drawings, in which:

FIG. 1 illustrates an example of machine worklog data generation and overlap resolution, according to an embodiment of the present invention;

FIG. 2 illustrates an example of a timber harvesting supply chain, according to an embodiment of the present invention;

FIG. 3 is a graph illustrating volumes of timber handled according to various operations of the supply chain of FIG. 2;

FIG. 4 is a flow chart illustrating a process for generating information related to a worklog, according to an embodiment of the present invention;

FIG. 5A is a block diagram illustrating apparatus and system components provided according to an embodiment of the invention;

FIG. 5B illustrates a system structure according to an embodiment of the present invention; and

FIG. 6 is a block diagram illustrating a system according to another embodiment of the present invention, of which the system includes a client private environment.

It will be noted that throughout the appended drawings, like features are identified by like reference numerals.

### DETAILED DESCRIPTION

Embodiments of the present invention provide for a method and apparatus for supporting forestry and timber harvesting, as summarized above. This may include timber harvesting management, e.g. by obtaining information about timber harvesting operations and using that information to direct further operations. Embodiments may involve the cooperation of timber handling machinery and (e.g. separately located) computing systems for managing timber harvesting operations. The machinery and computing systems can be communicatively linked, for example via a satellite or other communication network. Embodiments may facilitate efficient and effective operations by obtaining relevant data and processing it to provide relevant information for guiding the operations.

According to various embodiments, data from various timber handling machinery is obtained and processed to generate worklogs (electronic records). The data can include spatial location data (e.g. from a Global Navigation Satellite System (GNSS), such as the global positioning system (GPS)-based location tracker). The data can include data from sensors on board the machine, for example indicative of the state of the machine (on or off, idle or in motion), indicative of actions of the machine (e.g. detecting certain types of motions or activity), or the like, or a combination thereof. The data processing can be done locally to the machinery or remotely, or a combination thereof. The data can indicate where the machine has performed work (e.g. based on location data and machine state data), when the machine has performed work (e.g. based on time data and machine state data), and how the machine worked (e.g. indications of what work operations the machine performed, and influencing factors such as slope, machine size). Such data can be used to guide further aspects of the current operations, or as benchmark data for use in planning and/or evaluating future operations. Time data may include date, start and stop hours, minutes and seconds, or the like. The indication of where the machine worked may include an indication of an activity and/or harvesting campaign supported by the machine.

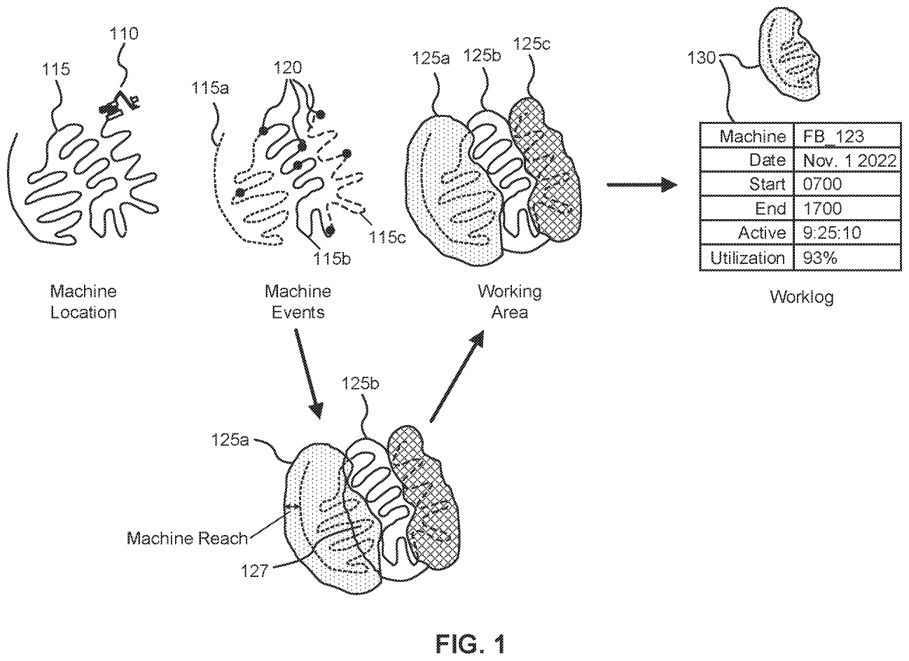

FIG. 1 illustrates an example of machine worklog data generation, according to an embodiment. As a machine 110 moves through an area, time and location data 115 is captured using a location tracker and an associated clock. The location tracker may be an Internet of Things (IoT) device with a GNSS based location tracker. The time and location data 115 is indicated as an overall history of a path taken by a machine, made from successive portions each of which represents the location of the machine at a corresponding time.

As the machine performs certain timber handling operations (also referred to as timber harvesting operations or work operations), machine events at corresponding times can be registered as event data 120. Examples of machine events include engine turning on, engine turning off, machine moving on, machine moving off, and GNSS position registered. Other possible events such as a fuel consumption log event can be recorded. Such other events can be but are not necessarily involved in worklog creation or recorded to worklogs. By way of example, the illustrated event data 120, represented as circles, can indicate a machine stopping for a period of time. The path of the machine, according to time and location data 115, includes path portions 115a, 115b, 115c corresponding to three separate time periods (e.g. days). Each one of these path portions, along with the machine events during such path portions, can be attributed to a different worklog. These path portions can be referred to as paths taken by the machine during a specified period. Alternatively, if the machine is substantially stationary or moves in a limited (e.g. closed-loop) manner, the path portions can be referred to as an area occupied by the machine during the specified period. The starts and ends of the path portions 115a, 115b, 115c can be determined based on a combination of time of day and event data. For example, the path portion ends can coincide with the location of a machine at a stopping event 120, when that stopping event is also the last event before a period of darkness (e.g. nighttime).

Based on the time and location data 115 and the event data 120, one or more working areas 125a, 125b, 125c of the machine 110 can be determined. The determination can be made using automatic data processing. For example, once the path portions 115a, 115b, 115c are identified as being attributed to different worklogs, corresponding working areas 125a, 125b, 125c can be defined, each surrounding a respective path portion. Details of the machine, such as its reach and indications (e.g. in the form of event data) that it performed timber harvesting operations, can be processed to determine what region surrounding the path portion (e.g. 115a) should be included in the corresponding work area (e.g. 125a). Overlaps within and between work areas can be resolved so that each area is only counted once, as described elsewhere herein. The work areas can also be subject to smoothing and other processing. The determination of working areas 125a, 125b, 125c can be described as a buffering process as applied to the respective path portions 115a, 115b, 115c. This buffering defines an area surrounding a path portion. The area may extend from the path portion to a distance which is based at least in part on a reach of the machine. The distance can further be based on considerations of resolving overlaps, or other smoothing or processing, or considerations of geographic features (e.g. roads, cliffs, physical or artificial boundaries).

Furthermore, based on the above information, including for example some or all of the time and location data 115, event data 120 and determined working areas 125a, 125b, 125c, one or more worklogs 130 can be generated for the machine 110. In various embodiments, a worklog includes an identifier for the machine, time information such as date, start time and stop time (e.g. for productive work operations), an indication of the amount of time the machine was actively performing productive timber harvesting operations, and a utilization rate. Utilization rate may refer to the number of productive working hours, divided by the total number of hours during which the engine of the machine was on. The utilization rate may be a useful metric for machine productivity. The worklog may indicate a particular forestry activity phase (e.g. harvesting, transportation, scaling), which may depend at least in part on the type of machine. The worklog may indicate the working area as a spatial region or geometry (e.g. as a set of geographic boundary coordinates or other indication which can be used to define a working area corresponding to the worklog). The worklog may be generated by a computer on board the machine, remotely by another computer, or a combination thereof. The worklog, or information for generating same, is communicated from the machine to a supervisory location for example via a satellite communication network.

The worklog may indicate a volume of timber handled according to the harvesting activity phase of the machine. The volume may be computed differently based on the type and/or activity of the machine. For example, for felling, the volume of timber felled in the worklog may be computed as the total merchantable volume, estimated from forest inventory information, and falling within the working area handled by the machine during the time covered by the worklog period. For primary transport, the volume may be computed similarly, but divided (e.g. equally) between multiple primary transport machines which operate in a same area. For processing, the volume may be computed from electronic reports (e.g. PRI files). For loading, the volume may be computed from load slips and weigh scale information at a mill.

The worklog may indicate work operations taken by the machine. Such work operations may be determined based on the type of the machine, recorded or sensed actions of the machine, or the like. Work operations can include, for example, felling, transportation, loading or timber processing operations. Work operations can specify a particular area in which they are performed. Work operations can influence computations such as volume of timber being handled. For example, when work operations include transportation operations, the volume of timber being handled can be computed in a particular way associated with primary transportation. When work operations include loading operations, the volume of timber can be computed in a different way associated with loading.

The worklog may further indicate a productivity of the machine. The productivity may be determined for example as the volume of timber handled per hour of active performance of productive timber harvesting operations, by the machine.

The worklog may indicate various factors influencing productivity of the machine. These may include, for example, mechanical factors, such as machine problems, or environmental factors, such as indications of difficult terrain, or weather conditions. Influencing factors may include worklog attributes used to describe the environment or situation the work was completed in. Worklogs may represent how and where an operator worked, including performance information such as active hours, utilization, and productivity. Information about the influencing factors on that work can be used to facilitate better understand of trends and variations in productivity between operations or machines based on working environment. This can also be used to benchmark expected productivity in different conditions, providing the groundwork for improving productivity and rate models.

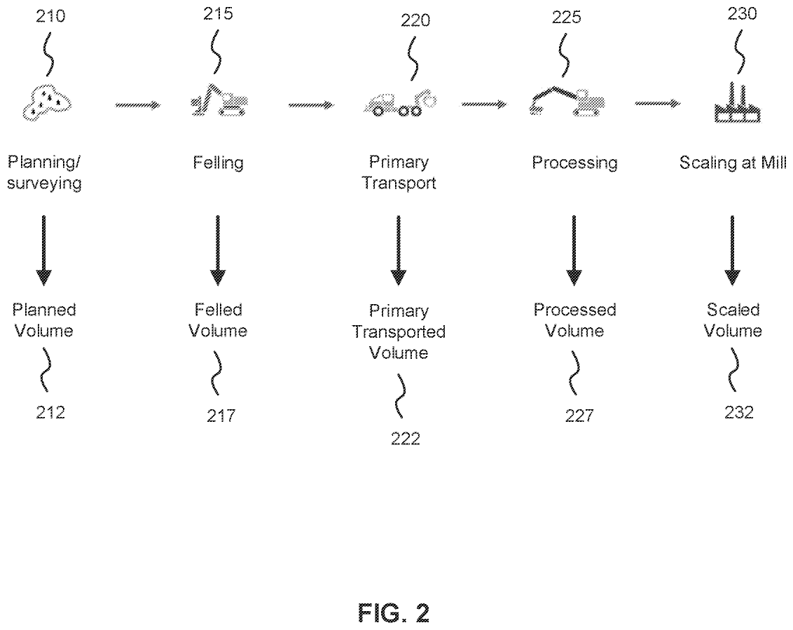

Worklogs can be generated by various types of equipment. Furthermore, in various embodiments, this information can be used to determine volumes of timber provided by different elements of the timber harvesting operation viewed as a supply chain. Accordingly, increased visibility into the timber harvest supply chain can be obtained according to various embodiments. For example, FIG. 2 illustrates a timber harvesting supply chain including the actions of planning 210, felling 215, primary transportation 220, processing 225 and scaling 230 at the mill. The supply chain may involve various operations involved to convert unfelled trees into timber products at roadside and ready for transport to a mill. Further processing at the mill is also performed, but for purposes of various embodiments this is considered beyond the timber harvesting supply chain, from tree-to-truck. (The planning 210 action, although important, might not be considered to be an actual part of the physical supply chain in all embodiments. Scaling 230 may also be considered outside of the supply chain being considered.) Nevertheless, each of these actions produces an associated volume of timber, shown as a planned volume 212, a felled volume 217, a primary transported volume 222, a processed volume 227 and a scaled volume 232. The volumes of timber obtained from at least some of these actions (e.g. felling, primary transportation, processing) can be determined using worklogs obtained from the machines that were involved in performing such actions. The variety of types and combinations of machinery makes it challenging to create worklogs in a universally applicable manner. However, according to embodiments, worklog creation is performed in a manner which is broadly applicable to different tasks while also being customizable to each of these different tasks. For example, by tracking the movement of machinery and based on the machinery type, working areas and volumes of timber handled by the machinery can be determined for different machines in a similar way.

It is noted that harvested timber volume information for each of one or more timber harvesting actions prior to scaling at the mill can be significantly beneficial to operations management. Previously, only information indicating an initially planned volume and a scaled volume (obtained when providing material to the mill) might have been available. However, in this case, only limited information could be obtained regarding the source of any discrepancy between planned volume and scaled volume. By determining the volumes at intermediate steps, and possibly with even more granularity (e.g. determining the volumes of individual machines at such intermediate steps), sources of inefficiency or volume losses can be determined with more accuracy, and supply chain visibility can be improved. Once determined, such inefficiencies or volume losses can be addressed to improve production. Furthermore, the information may represent reliable, real-time and objective updates indicative of multiple intermediate points in the supply chain (e.g. felling, transportation, processing and scaling at the mill).

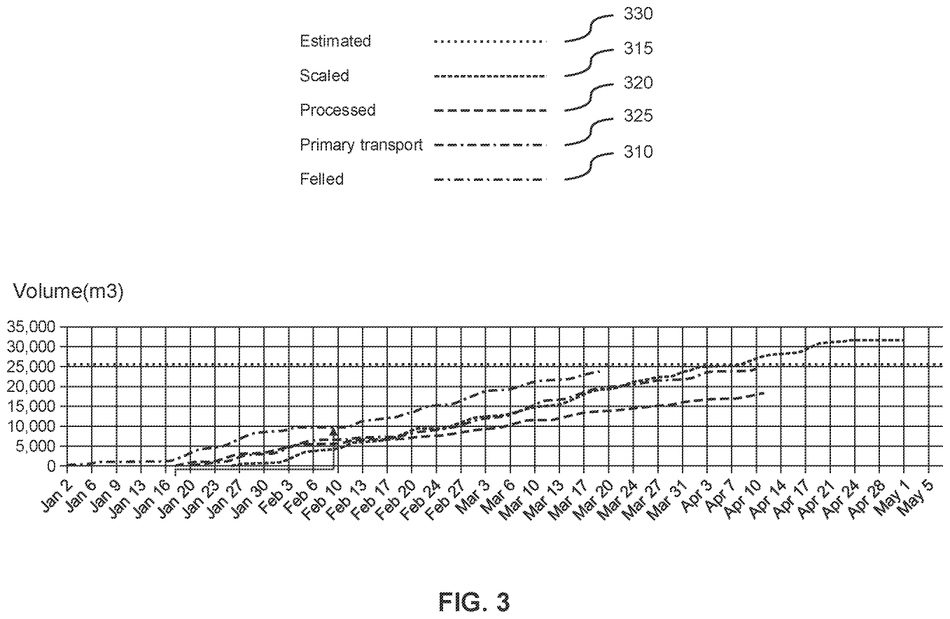

FIG. 3 graphically illustrates volumes of timber handled according to various operations of the supply chain of FIG. 2. The graph of FIG. 3 and related information can be obtained from worklogs and/or from the various actions in the supply chain of FIG. 2.

For example, FIG. 3 illustrates an estimated volume of timber 305, which can be generated during planning 210. This estimate is shown as constant, however updates of planning 210 can be performed which may change the estimate. FIG. 3 further illustrates a volume of timber 310 which is felled during the felling operations 215. The volume level evolves over time and the information may be obtained from worklogs of machines which participate in the felling operations (a type of work operation).

FIG. 3 further illustrates a felled volume of timber 310, a scaled volume of timber 315, a processed volume 320 of timber, and a (primary) transported 325 volume of timber. A total estimated volume 330 of timber, for example as derived from forest inventory data, is also shown. Primary transportation can involve yarding, skidding, hoe-chucking, forwarding, decking, cables, or a combination thereof. Scaling can involve weighing of trucks on a scale when entering the mill, to determine timber weight (with volume computed based on weight). Processed volumes correspond to output of a processor machine. A processor machine processes felled trees into logs of different sizes, as will be readily understood by a worker skilled in the art. These volume levels evolve over time and the information may be obtained from worklogs of machines which participate in the corresponding operations. More particularly, FIG. 3 illustrates evolutions, over time, of volumes of timber handled at each of a plurality of supply chain stages. This evolution can be ascertained by determining volumes at each of a plurality of successive times (e.g. days or portions thereof) and displaying the information graphically as a time sequence.

Primary transportation can take place following timber felling, to move timber from where it has fallen to a secondary (e.g. roadside) location. Processing can take place at this secondary location, which is still close to where the timber was felled, in preparation for further (e.g. truck) transport toward a mill.

Accordingly, embodiments of the present disclosure provide for visibility of the progress of multiple timber harvesting operations in a supply chain. The progress can be updated in real time or else according to a schedule. The progress can be expressed in terms of harvested volume and/or percentage of a total planned harvest volume. The multiple timber harvesting operations, for which progress is monitored and reported, can include operations performed during two or more of: felling, primary transport and/or processing phases of the supply chain. A dashboard or other user interface can display information such as that of FIG. 3, in order to convey information of current operations concurrently from multiple points of view.

Embodiments also provide for the ability to compare the progress of the above-mentioned phases with estimated harvest volumes, actual volumes of timber as delivered to the mill, or a combination thereof. For example, the total felled volume can be compared with the initially estimated volume to monitor for deficiencies in the estimation process and/or possible inefficiencies in the felling process. The total primarily transported (e.g. yarded or skidded) volume can be compared with the initially estimated volume and/or felled volume to monitor for deficiencies in one or more of: the estimation process, the felling process, and the primary transportation process. The total processed volume can be compared with the initially estimated volume and/or felled volume and/or primarily transported volume to monitor for deficiencies in one or more of: the estimation process, the felling process, the primary transportation process and the processing.

Volumes at two or more stages can be compared to identify possible inefficiencies, process issues, or reporting anomalies. The evolution of volumes over time can be analyzed to identify issues within or between processes, such as process bottlenecks or issues at the interface between processes. The volumes produced at multiple stages can also provide for monitoring of the process from multiple different perspectives for greater certainty and insight.

According to embodiments, and as also described elsewhere herein, information such as worklogs and timber harvest supply chain information (e.g. as in FIG. 3) are generated based on inputs such as monitored machine locations, engine events (e.g. start/stop events), machine working events, and the like. Inputs can further include enhanced forest inventory information. This information can be based on areas or individual trees. For example, enhanced forest inventory can be area based, which means that it takes the format of a 20 meter by 20 meter grid with forest statistics on each square of the grid. Enhanced forest inventory can also be an Individual Tree Inventory which means that the position of each individual tree is referenced with metrics associated. If Individual Tree Inventory is available, this information may be used to estimate volume. Otherwise, the area based EFI may be used. If neither of these two types of information are available, cruise based inventory may be used. Cruise based inventory considers that the volume is equally distributed over the area of the harvest block or other large general region. Forest inventory information can be obtained for example from satellite, aerial or ground surveys (e.g. cruise data), or a combination thereof, using Lidar, photography, or similar technology. Forest inventory information can indicate, for each given location in a forest, the estimated volume of timber at that location, if any. Forest inventory information can be used in generating initial volume estimates. Forest inventory information can be processed together with machine activity events to generate worklog information, such as volumes of timber felled or otherwise handled.

The information such as worklogs and timber harvest supply chain information can be generated further based on processor production files, scale data at entry to the mill(s) which process the timber, or a combination thereof. The processor includes a processor head, which is a piece of technology connected to a (e.g. embedded) computer collecting detailed information on what is processed, and related time and location information. This technology may be manufacturer specific but the output processor production files may follow the StanForD standard for the data. One of the main components of this standard are production files in PRI format. Embodiments of the present invention may collect these production files and send them to a destination (e.g. in the cloud) using an appropriate (e.g. satellite) communication link. The processed volumes, indicating volumes of timber output by processors, can be determined based on the content of the processor production files. Further to total volumes, in some embodiments, the processed volumes may be categorized by types or sizes of product output by the processors. For scale data, a comparison between the volume or weight of logs loaded onto a primary transportation truck and the volume or weight as delivered at the mill may be performed based on a load slip ticket system, to mitigate losses.

The information such as worklogs and timber harvest supply chain information can include, for example, daily records of volumes of timber handled at one or more stages of the supply chain, such as felling, transporting, processing, and scaling. The records may be generated on a per-tree-species basis, a per-end-user-product basis, or the like, or a combination thereof. The information may include progress charts, reports, raw or processed numerical data involving multiple fields (e.g. in a database), or the like, or a combination thereof.

Worklog generation according to various embodiments will now be described in more detail. A unit of worklog may represent a time unit (e.g. a day) of work with associated metrics. Notably, according to embodiments of the present invention, a unit of worklog is associated with a geolocated geometry, which indicates an area of forest upon which the machine associated with the worklog has worked during the time unit of work. This geometry can be generated in a manner as described elsewhere herein. Further, harvested volumes of timber, productivity measured in terms of volume per unit time (e.g. per hour) or both can be associated with units of worklog. Thus, a worklog can indicate a geographic area of work, and indications of volume of timber harvested.

As discussed previously, worklogs can be generated based on input information such as machine positions, engine events, machine working events, enhanced forest inventory information, processor production files, mill scale data, and the like. The worklogs may include worklog entities defined by a geometry, a date, a machine and a forestry activity phase. The worklogs may contain detailed information including volumes, productivity and various factors influencing the productivity.

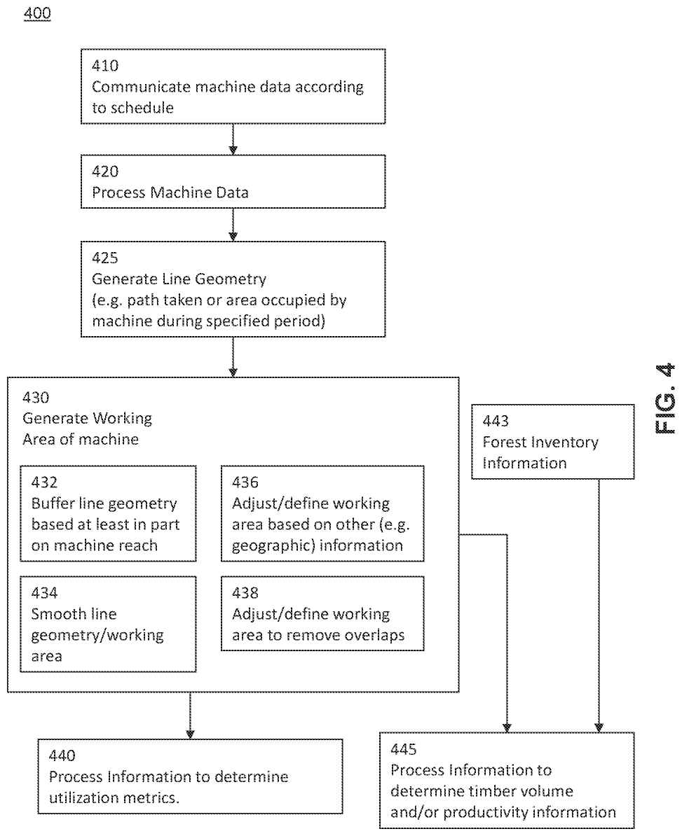

FIG. 4 illustrates a process 400 for generating information related to a worklog, according to an embodiment. The process 400 includes communicating 410 data according to a schedule, e.g. hourly. The communicating 410 may be performed using a data acquisition module. The data may be allocated into packets. The data packets are transmitted from timber handling machines performing the timber harvesting work, such as fellers, skidders, transports, processors, loaders, scales, etc. The data may be communicated via an appropriate network such as a satellite network, to a computer system remote from the machine. At least for remote and mobile such machinery (e.g. fellers), the data may be processed 420 to obtain information such as machine position, engine events, and machine working events, which can be components of a worklog. The processing 420 can be performed by a computer on-board the machine, by a remote computer, or a combination thereof.

Each machine, such as a feller, skidder, transporter, processor, or loader, may have one or more potential roles. Specialized machines such as fellers and processors may have just one role, e.g. felling or processing. Other machines may have two or more potential roles, such as transporting or loading. The role being performed by such a machine may be determined based on context information such as its location and movement patterns. For example, if a machine remains in the vicinity of a roadside timber pile, its role may be determined to be a loading role. If that same machine moves between the roadside pile and an area holding fallen timber, its role may be determined to be a primary transport role.

The process 400 further includes (as part of or subsequent to processing 420) generating 425 a line geometry from machine position data, such as reported GNSS points of mobile machinery. An example of a line geometry is the time and location data 115 as illustrated in FIG. 1. This line geometry can be created by generating line segments between reported (e.g. GNSS) positions and defining the line geometry as being formed by the generated line segments. The process 400 further includes generating 430 an indication of working area of the machine, which can be another component of the worklog. Generating (determining) 430 the working area may involve buffering 432 the line geometry based on information such as the machine reach to generate a spatial region surrounding the machine's path, where the spatial region is an inferred or estimated possible region upon which the machine performed work. The machine reach can indicate the size of area around the machine within which timber can be reached and handled by the machine. A smoothing 434 operation can also be applied to the line geometry and/or the working area to determine a realistic and/or useful version of the area. The region is also referred to as a working area. Other information, such as geographic information, indications of nearby roads, boundaries, or previously cleared areas, or the like, can also be used 436 to specify the working area. The working area may further be adjusted or defined 438 to remove overlap with other working areas e.g. which represent work performed previously. The process 400 may further includes processing 440 received and/or generated information (e.g. worklog components, machine working events) to determine one or more utilization metrics, such as the utilization rate. The process 400 further includes processing 445 received and/or generated information (e.g. worklog components such as working area, machine working events) to determine volume and productivity information. This may involve performing a spatial analysis in order to combine forest inventory information 443 with each defined working area, to effectively add up the volume of timber, as indicated by the forest inventory information, which falls within that working area. Such volume and productivity information can be determined in different ways for different machinery, as described in more detail elsewhere herein.

The term “buffering” as used above may refer to the Geographic Information System (GIS) technique of creating a polygon (buffer) around another geometry such as a point, line, or another polygon. Edges of the buffer polygon may be, for example, a predetermined constant distance or radius from the geometry which the buffer is created around. This buffering distance can be defined based on the machine reach, for example. If the buffering process creates a polygon which overlaps with itself, these overlaps can be resolved for example by merging them together.

Worklog generation can be different for different types of machinery. Similarly, a differentiated logic can be applied so that information received from different equipment is processed differently, based on type and role of that equipment. For some embodiments and with particular regard to felling machinery, worklog generation can be based on a combination of multiple sources and types of forest inventory. The working area (as a geographic area generated as described above) for felling machinery can be mapped against the inventory. Aspects of the worklog for felling machinery (e.g. working areas) can be determined using spatial and time overlap management techniques to avoid counting the same inventory twice.

Worklogs for felling machinery can be generated based on an area base from enhanced forest inventory. The worklog can be generated based on individual tree inventory. The worklog can be generated based on a cruise based inventory, which may include machine characteristics such as machine type and machine reach. The worklog can be generated based on information such as time and location data, machine state, and machine events. The worklog can be further generated based on a block boundary. Cruise based inventory may be generated by sending a cruise team on site to measure forest metrics on representative sample plots of the forest. These metrics may be extrapolated to obtain an inventory of the forest. The block boundary may be defined as the geographical limit of a harvest block (cut block, or operational unit). The block boundary may be the border inside which all trees should be harvested and outside of which no tree should be cut. The block boundary may be an input to used draw the work area of a machine, because even if a machine can drive and move outside of the block, no volume is to be felled (cut) outside of that boundary.

In addition to general processes as already described above, generation of worklogs for felling machinery can include the following. First, overlapping worklog geometries can be identified and the overlaps resolved. Overlapping geometries can include working areas (indicated in worklogs) for different machines, or for the same machines in different time periods, which spatially overlap. Such overlap, if not resolved, could result in double counting harvested volumes of timber. To resolve the overlap between two working areas, the working area that was handled earlier in time (according to a comparison of worklogs) is identified and the overlap region is attributed to that working area. The working area that was handled later in time is identified and the overlap region is removed (clipped) from that working area. Thus, in the case of overlapping working areas, the overlap is credited to the machine and worklog that first handled the overlap by harvesting timber within that overlap.

FIG. 1 illustrates an example of overlap resolution. The working areas 125a and 125b initially have an overlapping area 127. This overlapping area 127 is automatically identified by comparing the two working areas. Then, because the working area 125a was handled first, this overlapping area 127 is kept as part of the working area 125a and is deleted from the working area 125b.

The resulting regions (e.g. polygons) are then mapped against inventory information (e.g. a forest inventory layer in a GIS system) to compute volumes harvested per species, obtained from those regions. For example, the harvested working areas can be processed along with data indicating the estimated volumes of each species of tree within those working areas. This data indicative of estimated volumes can be the forest inventory information as described elsewhere herein. For mapping against inventory, a portion of the forest inventory which intersects the geometry (work area) of the worklog can be identified. This identification process may involve overlying the forest inventory geographic (map) information with the work area geographic (map) information and computing an intersection of the two. The planning stage may provide an expected forest inventory for a given harvest activity at the block level, however the inventory mentioned here may be a more detailed spatial representation of the inventory generally coming from survey Lidar data or other enhanced forest inventory information.

Feller productivity may also be determined from volume and working hour information. For example, the volumes of harvested timber, as determined above, can be determined on a per-felling machine basis, and these volumes can be divided by the working hours for those felling machines, to determine the productivity.

For some embodiments and with particular regard to primary transport machinery, worklog generation can (as above) be based on a combination of multiple sources and types of forest inventory. The working area (as a geographic area generated as described above) for the transport machinery can be mapped against the inventory. Overlaps in this case can be handled as collaboration areas involving multiple transport machines. Volumes of timber and productivity information can be shared between machines.

In more detail, as work areas (worklog geometries) may be obtained by creating a buffer around the tracks of the machines, and multiple machines may have moved over the same position, work areas will not generally be mutually exclusive but instead may be overlapping (intersecting). How these portions of work areas are considered differs based on the phase of operations (or supply chain activity). For felling, it is impossible that a tree is cut twice, therefore, if a machine drives over some pre-existing tracks, it is considered that only the first machine performed the cutting. Even if this were an erroneous assumption, it would still resolve double-counting issues. For primary transportation, the approach is somewhat different, because a first machine can pick up only a portion of the timber on the ground and a different machine can pick up a remaining portion later. Additionally, it is possible that a machine can deliver the same material partway to a destination, whereupon it is picked up by another machine for further transport toward the destination. Therefore, in some embodiments, a rule is followed by which, if multiple primary transport machines have worked on a common area, it is considered that they have collaborated and equally contributed to transporting the timber away from that area. The total volume of timber transported can then be divided (e.g. equally) between the machines. Even if this is not 100% correct it provides a workable model for tracking transportation.

Worklogs for transport machinery can be generated based on information which is similar to that for felling machinery, as set forth above.

In addition to general processes as already described above, generation of worklogs for (primary) transport machinery can include the following. Regions (e.g. polygons, working areas or worklog geometries) can be mapped against forest inventory information (e.g. a forest inventory layer in a GIS system) to compute volumes harvested per species, obtained from those regions. For example, the harvested working areas can be processed along with data indicating the estimated volumes of each species of tree within those working areas. This data can be the previously indicated forest inventory information. Transport machinery productivity may also be determined from volume and working hour information. For example, volumes of transported timber can be determined on a per-machine or per-group basis, and these volumes can be divided by the working hours for the machines or groups, to determine the productivity.

As with felling, a working area for a primary transport machine can be defined by determining a path travelled by the machine based on time and location data, and then buffering the path (e.g. based on a defined reach of the primary transport machine) to determine the work area. The primary transport machine will enter an area of forest, previously visited by felling machinery, and obtain fallen timber therefrom. The primary transport machine may make multiple trips into and out of an area of forest, and thus the path travelled may have several overlaps. However, by buffering the path and resolving overlaps to define a single region, these overlaps can be resolved. The working areas here represent the areas from which a primary transport machine obtained timber and transported it to roadside. It is noted that, when the harvest activity is complete, the union of all the felling working areas are expected cover a whole harvest block. The union of all primary transport working areas are also expected to cover the whole harvest block. In this case of full coverage, one can conclude that all the trees in the block were felled (cut) and that all the timber (e.g. tree trunks) were transported to the side of the road for processing and loading.

Furthermore, volumes and productivities can be shared with overlapping worklogs leading to an iterative re-evaluation of collaborative productivity. For example, if on a first day, Machine A and Machine B have both worked on a square of land with an estimated inventory of 100 cubic meters. It may be assumed that they have both transported 50 cubic meters. If on a subsequent day, Machine C is working on the same square of land, the worklog for this subsequent day for Machine C will be deemed to have a volume of 33 cubic meters and the worklogs for Machines A and B on the first day will be updated to 33 cubic meters instead of 50 cubic meters. Accordingly, the volume and productivity of a worklog can be retroactively adjusted if new information is added to the system.

Furthermore, volume and productivity metrics can be generated for groups of multiple transport machines which cooperate on a transport task. The cooperation can involve the multiple machines taking portions of timber from a same source and delivering to a same destination (or possibly different destinations). The cooperation can involve the multiple machines working entirely in parallel or can involve some machines working in a staged relay relationship. Such a group can be evaluated as a whole with respect to processed volume and/or productivity, rather than or in addition to individual machines being evaluated. Hierarchical groupings, e.g. groups of groups, can also be defined and evaluated in this manner.

In addition to general processes as already described above, generation of worklogs for processing machinery can be characterized by the following. Embodiments exhibit a streamlined use of PRI files, as sent by processing machines. These files may contain details of the logs of timber (cut to a given dimension), processed by product class. Embodiments can be configured to associate volumes of processed timber, as produced and reported by processing machines, to a correct corresponding block. In this context a block designates a piece of land to be harvested by contract. These geographical units are predefined and referenced as where the timber comes from throughout the supply chain. The same machine may work throughout the day in different cut blocks. The Processing files contain detailed information on the timber processed but not in which block it was processed. Therefore, according to embodiments, spatial analysis may be performed to identify where the timber was processed and/or the origin of the timber which was processed. Associating a volume of processed timber with a block may comprise tracing, based on worklogs, which block the timber came from. A pile of wood that was processed can be traced back to original locations by examining worklogs of transport machinery, for example.

Worklogs for processing machinery can be generated based on machine characteristics, such as machine type and reach. Processing machines can reach for and obtain timber from stacks within a predetermined local region, and once obtained, process such timber. Processing refers to an operation of cutting trees into products, e.g. logs of specified size and species. Worklogs for processing machinery can be generated based on the physical location of the machinery, for example as indicated by GNSS position. Worklogs for processing machinery can be generated based on machine working events and/or engine events. The worklog can be generated based on a block boundary. The worklog can be generated based on PRI files, for example indicating total volumes of timber processed, volumes of timber processed on a per-forest product basis, or a combination thereof. Forest products may be specified for example based on a combination of length, diameter and species of timber.

In addition to general processes as already described above, generation of worklogs for loading machinery can be characterized by the following. Embodiments can use scale actuals and/or electronic load slip tickets to associate scaled volumes to the loader machine which performed the loading. For example, once timber is scaled at mill, the scale weight and load slip ticket information can be used to identify a time and location of the loading. This time and location information can be used to query a database containing worklog information to determine a loader or loaders which were operating at that time and location. Embodiments can involve detecting of the various phases of work of a loader based on proximity to the road, proximity to other machine types or time dependency to previous phases. For example, based on location of a loader machine relative to other relevant machines or features, the current role of the loader can be inferred. Then, this information can be incorporated into the worklog or otherwise used in its generation, to indicate the activities performed by the machine.

In more detail, a single loader machine can be capable of performing different jobs (roles) in the field. These different jobs may be paid at different rates and/or might not be accounted as being part of the same phase. The job being performed by a loader machine may be inferred from data such as its location, its pattern of travel, the location of other machinery (e.g. in close proximity), the reported activities (or lack thereof) of such other machinery in close proximity, or the like, or a combination thereof. In some embodiments, by way of example, if the loader machine is on the road or at road side and a worklog for a processing machine located in the same area indicates that some processed logs are available to be loaded, this information may be combined to determine that the loader machine is considered as loading the logs onto a truck to be sent to the mill. If the loader machine is away from the road, it may be considered to be participating in primary transport (e.g. then considered as “hoe-chucking”). If the loader machine is on the road or at roadside but that no processor has reported work in the area, the loader may be considered to be creating road-side piles to be processed by processor.

Worklogs for loading machinery can be generated based on scale data, electronic load slips, machine characteristics, machine working events and/or engine events. A load slip may be a ticket that can be printed on paper or digitally created when a loader loads logs onto a truck. The load slip may be given to the truck driver and provided to the mill when the logs are delivered to the mill. Load slips are often a legal obligation in forestry, and include the nature and volume of logs loaded onto the truck and ensure the tracking of the origin of the timber.

Productivity for loading machinery can be determined for example as described elsewhere below.

For loading machinery activity, overlap with roadside piles (of timber) may be assessed based on previous processing machinery worklogs. For example, the presence of processed logs to be loaded onto a truck may be indicated by an existing processor worklog, which is evidence that a processor did work in that specific location. Similarly, roadside piles and proximity to a road may be used to distinguish loading from primary transport activities. For example, when a machine with loading capabilities operates in a working area which includes roadside piles of processed timber, its operations can be inferred to be loading activities.

As already described above, volume and productivity information in relation to timber handling can be generated for various machinery and/or supply chain stages. The volume and/or productivity information can be obtained from a variety of sources. Furthermore, in various embodiments, volume and/or productivity information can be obtained from multiple sources and presented together. Additionally or alternatively, the volume and/or productivity information from different sources can be processed together to determine whether and/or to what extent the information from different sources is in agreement. This can facilitate a comparison of the information from different source to provide for a more detailed perspective.

A first source of volume information is cruise inventory from a planning stage, involving survey or inventory crews as previously mentioned.

A second source of volume information is Lidar inventory information, e.g. Lidar enhanced forest inventory information. As will be readily understood, such information can be obtained using ground-based, aerial or satellite-based forest inventory equipment and may indicate timber volumes as a function of location, potentially distinguished by species. For example, Lidar inventory information can indicate the locations of trees and the approximate volumes of each tree. Additionally or alternatively Lidar inventory information can indicate the approximate volumes of timber for each (e.g. 20 meter by 20 meter) general location in an area.

A third source of volume information is processor head data, as mentioned above. As the processor operates, it records data indicative of volumes of timber which it processes, thereby providing such a source of volume information.

A fourth source of volume information is scale data, for example as provided from weigh scales used at a mill site, particularly when receiving product. For example, third party software connected to electronic scales at the mill may collect data indicative of loads delivered to the mill. This data may include information on the volume, the species and the forest products as well as additional info such as the time of the delivery, the block where the timber comes from and possibly the truck that transported it, the time and exact location where it was loaded onto the truck, the name of the loader machine that loaded the truck, or the like.

Each of the above sources of volume information may include an indication of a volume of timber at a particular stage in the supply chain. Volume information can be inferred from given information for example by translating image data into volume data, or weight data into volume data. A scale weight can be translated into a spatial volume for example based on an indication of average density of the timber species being processed. Lidar information can similarly be processed (e.g. using machine vision computations or machine learning.) to estimate useful volume based on Lidar image readings.

In various embodiments, multiple different versions of the volume data and/or the productivity data (based on the volume data) are determined and presented together. This information can be computed based on relevant worklogs from appropriate points in the supply chain. For example, felled volume can be determined based on worklogs from felling machinery, in combination with forest inventory (e.g. Lidar) data, using spatial analysis. This can involve determining a working area and processing the working area together with the forest inventory data to determine the volume of timber. Volume of timber handled by primary transporters can be similarly determined based on worklogs from felling machinery in combination with forest inventory (e.g. Lidar) data. Volume of timber handled by processors can be determined based on processor head data. Notably, this approach provides an indication of volume that is not dependent on inventory data. Thus, the volume based on processor head data can be compared with the volumes based on inventory data.

Volumes of timber handled by loaders can similarly be based on processor head data, scale data, or a combination thereof. For example, a loader will load timber onto a transport and a load slip ticket will be issued. The transport will then be weighed at entry to a mill and the weight reported along with an indication of the load slip ticket. Based on this report, the loader will be credited with loading a certain weight or associated volume (determined from weight) of timber. Notably, this approach provides an indication of volume that is not dependent on inventory data or processor head data, and may thus provide for a third independent source of volume information.

Volume from processor head data can be determined based on worklogs from equipment at the processing stage. Volume from scale data can be determined based on worklogs from associated equipment at the or prior to the mill. The different volume information can be used to bring additional perspective and understanding of the harvesting supply chain. Rather than treating volume data from one source as “true,” the volume data from different sources can be treated as representing different perspectives. This volume data from different perspectives can be automatically compared (e.g. via subtraction or graphically by highlighting the differences), and the results of the comparisons can be presented. Thus, for example, the degree to which volume data from different sources agree or disagree can be provided as output for consideration by users, benchmarking systems, or AI systems.

Volume and productivity information can be generated based on a variety of inputs. Volume and productivity information can be generated based on worklog geometries, which may be the working areas indicated in the worklogs, after processing to remove (resolve) overlap. Volume and productivity information can be generated based on block boundaries. Volume and productivity information can be generated based on planned volumes, which in turn may be based on inventory data or the like. Volume and productivity information can be generated based on enhanced forest inventory. Volume and productivity information can be generated based on processor PRI files. Volume and productivity information can be generated based on scaled volumes from the mill. Volume and productivity information can be generated based on working hours, as obtained from machine data (e.g. as indicated in worklogs).

In various embodiments, each type of machine, or machines at each point in the supply chain, may have a corresponding primary source of information for use in determining volume and/or productivity information. Thus, different instances of the volume and productivity information sources as specified above can be used for different instances of timber harvesting/handling machine. Productivity can be computed based on this primary source of volume information in real time or in near-real time.

In some embodiments, when harvesting operations are completed for an associated block of forest (also referred to herein as a “block” or “cut block”), the volume and/or productivity information for that block of forest, from a harvesting perspective, may be deemed available. Similarly, when transport, processing or scaling operations are completed for timber from an associated block of forest, the volume and/or productivity information for that block of forest, from those perspectives, may be deemed available. In this case, the volumes and productivities that are deemed available can be used as a baseline, and the volumes and productivities coming from other perspectives, downstream in the supply chain and for the same block of forest, can be pro-rated and calculated for each worklog, for example using the baseline.

As an example, a felling worklog may have a first associated volume (e.g. 100 cubic meters) which is a fraction of a total estimated volume (e.g. 1000 cubic meters) contained in the entire block based on the forest inventory. However, once the block is fully harvested, the total volume of timber scaled at the mill may be less than the total estimated volume (e.g. 950 cubic meters). Then, by pro-rating the scaled volume to the worklog level, it may be calculated that the volume scaled for the felling worklog is 95 cubic meters. The same way, if, when the block is completed, the total volume processed in the block is 1200 cubic meters, then the volume processed for this felling worklog may be pro-rated to 120 cubic meters. As there are multiple sources of data, each providing a version of the volume for the entire block, each worklog may also have different version of the volume. In the case above, the felling worklog will have: a volume from inventory of 100 cubic meters; a volume as-scaled of 95 cubic meters; and a volume as-processed of 120 cubic meters. Volumes associated with worklogs can be adjusted based on volume information from other worklogs.

As will be evident from the above, volume information generated by the above can include anticipated timber volumes determined from forest inventory activity, anticipated timber volumes determined according to planning operations, timber volumes processed, timber volumes scaled (at mill entry), or the like. Productivity information generated by the above can include anticipated machine productivity determined from forest inventory activity (productivity inventoried), anticipated timber machine productivity determined according to planning operations (productivity planned), harvesting machine productivity, transportation machine productivity, processing machine productivity (productivity processed), scaling productivity (productivity scaled), or the like.

As mentioned above, volume information and/or productivity information can be determined based on forest inventory information, according to a spatial analysis. For example, when a machine operates on a determined working area, the timber contents of that area can be determined based on such inventory information, so that volume of timber worked on and associated productivity data can be computed. In more detail, the forest inventory information can be represented as a geographic map partitioned into a set of unit locations, with each unit location being assigned a volume of timber. When a working area includes a unit location (e.g. a pixel or grid square), the volume of timber assigned to that unit location is added to the total volume of timber handled in that working area. When a working area includes a fraction of a unit location, the volume of timber assigned to that unit location, multiplied by the fraction, is added to the total volume of timber handled in that working area. The working area can be obtained from a worklog, for example as a geometrically defined geographic area. The total volume of timber handled in the working area is a sum of such volumes, across all unit locations and/or fractions thereof included in the working area. Volumes of timber in a working area and unit location can also be distinguished by type and/or species, each counted separately to determine total volumes thereof. Accordingly, a determined working area can be mapped against the forest inventory. Furthermore, the volume information for a working area can be computed according to a spatial analysis. The spatial analysis, e.g. as performed in GIS software, may involve adding all timber volumes intersecting spatially with the working area, where a timber volume is associated to each pixel (or unit element) on an inventory layer of a map. This spatial analysis may alternatively be described as processing a working area of a machine together with forest inventory data (or other data indicative of estimated volumes of timber for a region) to determine a volume of timber handled for that working area.

The forest inventory information can include a Lidar-enhanced forest inventory. Such an inventory can be determined using a combination of sources of information, of different types. Various technologies can be used to estimate the volume of timber in a given area, potentially distinguished by type or species. Information can be gathered using satellite-based, aerial or ground-based platforms. Information can further be obtained through visual or photographic systems, Lidar systems, machine vision, or the like. The information can be given a suitable resolution, for example so that each 20 meter by 20 meter grid square of terrain is assigned its own respective timber volume information. The forest inventory information can be based on unit areas as above. The forest inventory information can additionally or alternatively be based on individual trees at specified locations, in which case a unit location may be, for example, a geographically specified tree.

In some embodiments, when multiple sources of forest inventory information are available, one of these sources (e.g. the best available) is selected for use in computations based on the working area being mapped against the forest inventory. For example, if timber volume information for a working area at particular geographic coordinates is to be determined, and the most accurate, highest resolution, or a combination thereof, source of forest inventory information for that working area is aerial Lidar information, this source of forest inventory information is processed together with the working area to determine volume of timber handled.

In various embodiments, when determining volume information for a working area based on forest inventory, previous depletion of timber from that working area (e.g. during the same harvesting campaign) can be accounted for. This may involve, as already described above, clipping (deleting) a working area where it overlaps with other previously logged work areas, to resolve the overlap. Similarly, when another feller has performed felling activities in a given working area, the volume of timber felled by that other feller in the working area can be subtracted from the estimated volume of timber felled by the current feller, to avoid double counting. More generally, for a given timber handling machine performing a role, when another timber handling machine having the same role (e.g. felling, transport, loading, processing) has operated in a working area of the given timber handling machine, such operation can be taken into account when estimating volumes of timber handled by the given machine for the working area, or for an associated region. This accounting generally reduces the estimated volume of timber handled by the given machine for the working area, instead attributing the amount of this reduction to prior machines having the same role and operating in the working area.

Determining volume information for a working area based on forest inventory while accounting for previous depletion of timber from that working area may additionally or alternatively involve updating the forest inventory for a given spatial region based on information on prior activities in that region, such as road building, area clearing, and timber harvesting.

As with previous embodiments, once volume information for a working area is computed, productivity information for that working area can also be computed based on the volume information along with time information such as working hours by a machine or group of machines in the working area.

According to embodiments, when determining working volume and productivity information based on planned inventory, a planned cruise volume at the harvesting campaign (for an entire cut block) level may be utilized. This level is also referred to as the overall activity level (or block level), referring to the volume for an entire cut block. This volume may be prorated to a working area of a worklog based on inventory distribution. A harvesting campaign (for cut block) level volume, from inventory information, may be obtained. A harvesting campaign (for cut block) level planned volume may also be obtained. A worklog level planned volume may also be obtained, e.g. indicative of the planned volume (from forest inventory data) for a working area associated with a worklog. The worklog level volume is associated with the working area of a worklog, whereas the campaign level volume is associated with an entire cut block. This may be defined at the block level (or activity level), and may be pro-rated to determine which portion of the volume planned was handled by a specific machine on a given day (worklog level). Based on this, the planned volume of timber handled for a working area or associated worklog may be obtained by prorating the volume planned for the full harvesting campaign (on the cut block) to the working area. This may provide for a planned volume of timber handled and/or a planned productivity, for a working area or associated worklog.

According to embodiments, when determining working volume and productivity information based on processor head data, data (e.g. PRI files) from processor machinery may be extracted in real time using suitable programs and communication (e.g. satellite) links. Processed volumes of timber can be compared to scaled volumes (e.g. as entering the mill). The comparison can be made on a per-forest product basis. Accordingly, loss information such as volume of product left at roadside can be determined. The PRI files may be formatted as StanForD files for example, where StanForD is a forest machine communication standard as will be readily understood by a worker skilled in the art. PRI files refer to production-individual files holding harvesting data (e.g. length, diameter and volume) for each individual log and stem. Machine characteristics, such as machine type and reach, as well as machine working and engine events, can also be used to determine such working volume and productivity information, such as volume of processed timber and processing productivity data.

In more detail, PRI or similar files may be received and parsed. Locations of processor machines can be analyzed to associate the volume of timber being processed to the appropriate block. Based on the block, date and machine identifier, volumes of timber are associated with the appropriate worklog. Productivity is again computed based on volume and working hours.

According to embodiments, determining working volume and productivity information based on scale data may involve communication with a third-party system, such as scale machinery at a mill. By obtaining scale data, a comparison can be made between scaled volumes, as indicated in such scale data, and loading volumes, as indicated in data obtained from prior or subsequent loading operations. Mismatches can be identified and reported, or the working volume and productivity information based on scale data can be reported on its own for comparison with other sources of volume and/or productivity information. Scale data can be obtained from such scaling machines. Electronic load slips, machine characteristics, and machine working events and engine events an also be obtained. Scaled volumes indicated via the mill's scale data and load slips can be obtained regularly, e.g. daily.

According to embodiments, volumes indicative of timber that is loaded and scaled are mapped to the appropriate loaders. Furthermore, as described elsewhere, productivity can be determined based on volume and machine working hours. This allows for volumes and productivity as reported by mill scales to be reported. For example, per load slip ticket evidence, the volume loaded on a truck and the volume delivered at the mill are expected to match exactly. This information is available to the system once the scale software at the mill reports this volume. The volume loaded is assigned to the loaders working on the block where the delivered timber comes from.

In more detail, the volume of timber handled by a loader and/or delivered to mill can be associated with a particular source location as follows. The volume itself can be determined based on weigh scale information at mill. The volume can be associated with a particular loader or set of loaders via information on the load slip tickets for the timber as weighed. The location(s) of these loaders can be determined based on identifiers of the loaders, as indicated on the load slip tickets. The identifiers can be used as a basis for a query performed on loader worklogs, to determine locations of the loader(s) at relevant time(s) indicated by the load slip tickets or related information. This provides for a general location of origin of the timber.

Furthermore, worklogs (or information obtained from such worklogs) of machinery upstream in the supply chain, in that same general location, can be identified and processed to obtain further information and to map the volume of timber handled by the loader to a particular prior (e.g. origin) location. For example, based on worklogs of a loader and associated processors, it can be determined that the loader performed work in the vicinity of a particular processor. Then, the volume of timber reported by that processor at that location can be associated with the volume of timber handled by the loader. Furthermore, based on worklogs of fellers and/or primary transporters, it can be determined that timber cut from a certain origin location was delivered to a location of that processor. Then, the timber handled by the loader can be associated with this origin location. Additionally, the volume of timber handled by the loader can be associated with estimated volumes from forest inventory data for these origin locations.

Similarly, the volume of timber handled by a processor can be associated with a particular source location as follows. The volume itself can be determined based on output of PRI files. Such a reported volume can be associated with a location of the processor at the time of PRI file generation. This provides an indication of a volume of timber processed at a particular location. This provides for a general location of origin of the timber.

Furthermore, as with the loader case, worklogs (or information obtained from such worklogs) of machinery upstream in the supply chain from the processor, in that same general location, can be identified and processed to obtain further information and to map the volume of timber handled by the processor to a particular prior (e.g. origin) location. For example, based on worklogs of fellers and/or primary transporters, it can be determined that timber cut from a certain origin location was delivered to a location of the processor. Then, the timber handled by the processor can be associated with this origin location. Additionally, the volume of timber handled by the processor can be associated with estimated volumes from forest inventory data for these origin locations. Thus, data (e.g. PRI files) from a processor can be mapped to an originating area for the timber processed thereby. Similarly, the association between volume handled by loader and volume handled by processor, as explained above in the context of a loader, can be used to determine volume of timber handled by a processor based on load slip information.

In various embodiments, worklog influencing factors can be determined and reported. These can include ground slope, stem density, stem size, boom reach, and machine size. Influencing factors can represent contextual information which influences timber harvesting operations, such as their speed, mode pattern, or efficiency. Such contextual information can be recorded and used in understanding operations, as well as for benchmarking and subsequent analysis.

Influencing factors can include worklog attributes used to describe the environment or situation the work was completed in. Worklogs represent how and where an operator worked, including performance information such as active hours, utilization, and productivity. By including information about the influencing factors on that work, one can better understand trends and variations in productivity between operations or machines based on working environment. This can also be used to benchmark expected productivity in different conditions, providing the groundwork for improving productivity and rate models. Influencing factors are calculated using the spatial and temporal information from the worklog. All influencing factors may be added when a worklog is created by spatially intersecting, clipping, and calculating the relevant ancillary data. In some embodiments, if a worklog is re-created for any reason, new influencing factor attributes may be calculated for it with the currently available ancillary data.

In various embodiments, the worklogs can be used to facilitate benchmarking. In benchmarking, worklogs related to a harvesting campaign (on one or more cut blocks) are analyzed, for example after a timber harvesting campaign is completed. The worklogs may be anonymized prior to such analysis, for example by removing or encrypting spatial information, names, or tenant information. Anonymized worklogs may be stored in a database table. Benchmarking can involve processing the worklogs to determine expected volumes and productivities, and associated losses, for comparison of multiple timber harvesting operations, either past or prospective.

Worklogs, reports, forestry inventory data, indications of harvesting activities, influencing factors, or other ancillary data can be entered into a benchmarking database, the contents of which can then be analyzed. The analysis can involve determining the efficiency of forestry machines operating under certain environmental variables. For example, the database may include worklogs indicative of forestry activities in a certain environment (e.g. including weather or geography). These worklogs can be retrieved from the database by querying the database for these environmental factors. Then, the worklogs can be analyzed to determine the efficiency and effectiveness of different forestry activities in that environment. This information can be used as a benchmark for future activities in similar environments. This information can also be used to anticipate and address challenges in that environment.

In various embodiments, the anonymized worklogs can be provided to an artificial intelligence (AI), machine learning or similar computerized predictor system, in order to train (configure) the system to perform prediction operations based on previously obtained data. For example, the AI can be trained to perform prediction tasks, such as predicting how long it will take, by phase, to complete a harvest block, or predicting volume and productivity information. The predictions can be based on prior benchmarking data for one or more comparable timber harvesting operations. The machine learning operation can involve random forest machine learning or deep learning.

Accordingly, by observing the various phases of one or multiple timber harvesting operations, data can be obtained which includes forest inventory information, as well as information regarding subsequent timber harvesting operations. The information may include volume and productivity data, and/or timing of operations from worklogs. This allows associations to be determined between such forest inventory information, and related geographic information, and the outcomes of timber harvesting operations, including volumes, productivities and timings. Such associations can be used to predict the outcomes of further proposed timber harvesting operations using such associations and based on initial forest inventory information, and related geographic information. The predictions can be performed by training an AI or similar system and then using that system to make the predictions.

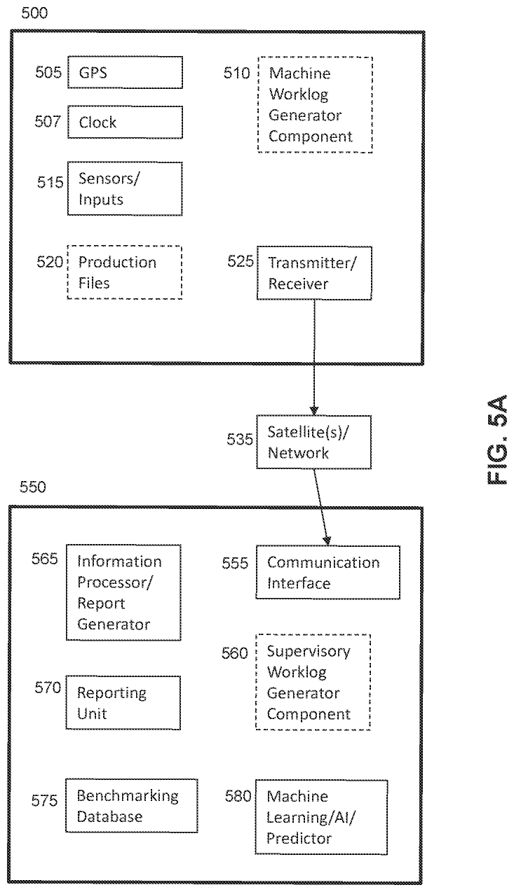

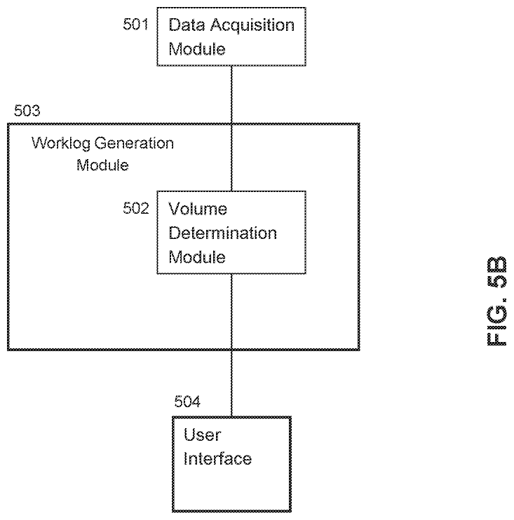

FIG. 5A illustrates apparatus and system components provided according to an example embodiment of the invention. A timber-handling machine 500 deployed in the field includes a GNSS 505 or other type of location tracker and a clock 507. The GNSS 505 and clock 507 generate location and associated time information which is provided to one or more worklog generation components. The worklog generation component(s) determine a path taken or area occupied by the machine 500 during certain periods based on this location and associated time information. For example, the time series of GNSS locations can be taken together as an indication of the path taken. If the GNSS location does not change over time, or only changes by a limited amount, that GNSS location, or a region encompassing the limited range of GNSS locations, can be indicative of the area occupied by the machine. This can be the case for a substantially stationary machine.

The worklog generation component(s) potentially include one or both of an on-board machine worklog generation component 510 and a remote (supervisory) worklog generation component 560 at a supervisory (e.g. head office) location 550. Accordingly, worklogs can be generated at the machine, or at the supervisory location based on provided information, or a combination thereof. In the following it is assumed that the on-board machine worklog generation component 510 is present. However, if the on-board machine worklog generation component 510 is absent, raw data from the GNSS, clock, sensors, or the like. can be transmitted to the supervisory location and used by the remote (supervisory) worklog generation component 560 to generate the worklogs.

The machine worklog generation component 510 can also obtain data from machine sensors and/or user inputs 515. For a processor machine, production (PRI) files 520 can also be provided to the machine worklog generation component 510 or alternatively these can be transmitted separately. Based on the information it receives, the machine worklog generation component 510 can generate worklogs or worklog precursor data as described elsewhere herein. Worklog precursor data may include information to be further processed by the remote (supervisory) worklog generation component 560 in order to generate worklogs. The worklogs or worklog precursor data from the machine worklog generation component 510 is provided to a transmitter/receiver 525 which communicates the information to a corresponding communication interface 555 of the supervisory location 550 via appropriate intermediate network equipment 535, which may include one or more satellites or other wireless communication infrastructure.

The remote (supervisory) worklog generation component 560 may receive worklog precursor data from various machines and generate worklogs based thereon, for example by removing or resolving overlaps from working areas of machines and performing other operations such as working area boundary smoothing or adjustment, and determining utilization metrics and timber volumes. Some of these tasks can also be performed at least partially by the on-board machine worklog generation component 510.

Once worklogs are generated, e.g. by the supervisory worklog generator component 560, they are provided to an information processor and/or report generator 565 at the supervisory location 550. This component can, for example, for each stage in a timber harvesting operation supply chain: determine an evolution, over time, of volume of timber handled at said one of the plurality of stages. Once determined, this information can be provided to a reporting unit 570. The reporting unit can include or be coupled to a user interface and can operate to present, via the user interface, a combined indication of the evolutions, over time, of the volumes of timber handled at each said one of the plurality of stages. This facilitates ongoing monitoring of operations with information representing multiple supply chain perspectives.

Once worklogs are generated (and possibly upon completion of a harvesting campaign or portion thereof), they can be recorded to a benchmarking database 575 and/or directly or via this database to a machine learning, AI and/or prediction component 580. The machine learning, AI and/or prediction component can use this data to generate predictions for future operations.

FIG. 5B illustrates a system structure according to an embodiment of the present invention. The system includes a data acquisition module 501, a volume determination module 502, a worklog generation module 503 and a user interface 504.

The data acquisition module 501, which is configured to obtain information from the timber handling machine, can include the machine worklog generator component 510 and/or the supervisory worklog generator component 560. The data acquisition module 501 can include the transmitter/receiver 525 and the communication interface 555. The data acquisition module will obtain the information from the GNSS 505, clock 507, sensors 515, or the like. and provide such information for processing by the volume determination module 502.

The volume determination module 502, which is configured to determine a volume of timber handled by the machine, can include the machine worklog generator component 510 and/or the supervisory worklog generator component 560. Furthermore, the machine worklog generator component 510 and/or the supervisory worklog generator component 560 may be parts of a worklog generation module. Determining a volume of timber handled may be performed as part of generating a worklog, as described elsewhere herein. Thus, the volume determination module 502 may be part of the worklog generation module 503. Determining the volume may include determining the path taken or area occupied by the machine, determining the work operations of the machine, determining a working area surrounding the path taken or area occupied, and processing the working area together with forest inventory data to determine a volume of timber handled. The determined volume of timber handled and/or other relevant information may be presented to a user via the user interface 504.

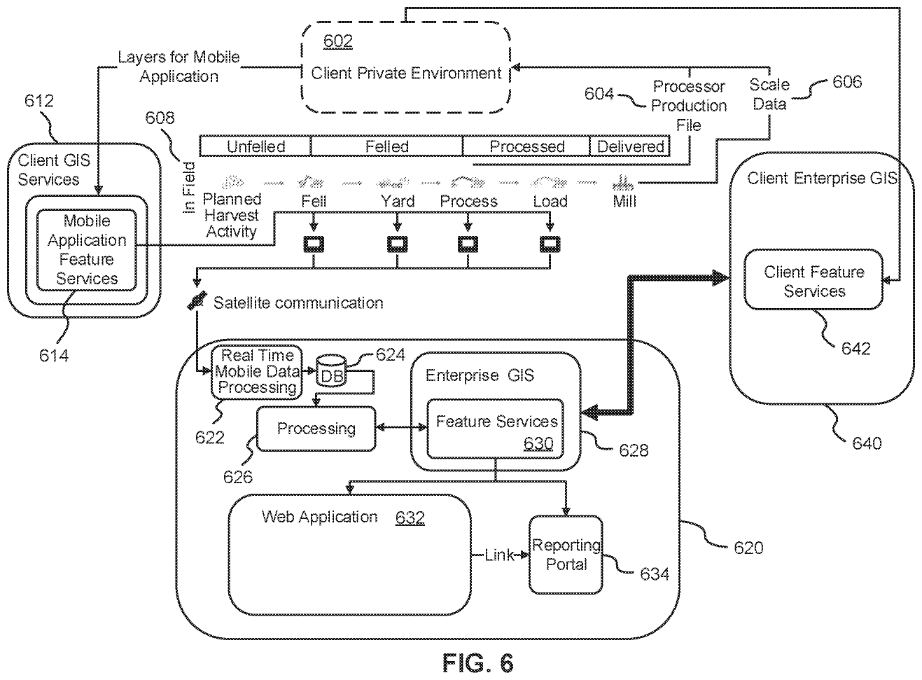

FIG. 6 illustrates a system according to another embodiment of the present invention. The system includes a client private environment.

The system includes a client private environment 602, a timber harvesting supply chain 608, a client GIS services module 612 including a mobile application feature services sub-module 614, a supervisory module 620, and a client enterprise GIS 640 including a client feature services sub-module 642.

The client private environment 602 receives information such as processor production (PRI) files 604 from processors in the supply chain 608, and scale data 606 from mill scales. The client private environment provides information to the client feature services sub-module and the mobile application feature services sub-module 614. Information (e.g. worklog information) from the field, such as data from felling, primary transport (e.g. yarding) processing and loading machinery are collected by mobile applications 609 operating on-board such machinery. The mobile applications 609 may generate or assist in generating worklogs. This information is communicated, for example via a network including a satellite link, to the supervisory module 620.

The client GIS services module 612 includes map information to be displayed on the mobile application for navigation. Instances of the mobile application are deployed on harvesting machinery and may include a display usable by the operators for navigation and direction of work tasks. The display may show GIS information, for example. The mobile application feature services sub-module can similarly include information which is used by and/or directs operation of the instances of the mobile applications deployed on the machinery.

The supervisory module 620 includes a real-time mobile data processing sub-module 622 which processes data received from the mobile applications 609. This processing may include or support the generation of worklogs. The supervisory module 620 further includes a database 624 which stores data (e.g. worklog data) from the real-time mobile data processing sub-module 622. The database 624 may operate at least in part as a benchmarking database. A further processing sub-module 626 can operate to retrieve and process data from the database 624. This further processing can include processing according to machine learning operations. Additionally or alternatively, the further processing can include generating or adjusting worklogs. The further processing sub-module 626 can interact with a feature services sub-module 630 of an enterprise GIS 628. The feature services sub-module 630 can further interact with a web application 632 and a reporting portal 634. Furthermore, the client enterprise GIS 640 can share information with the enterprise GIS 628.

The client feature services sub-module 642 includes input data (e.g. in spatial and/or tabular form) used for generating worklogs. Such data may include forest inventory information, processor production files as received, volumes scaled at the mill, planned volumes and block boundaries. The data provided via the client feature services sub-module 642 can be used in generating information such as the volume of timber handled by a machine in association with a particular worklog.

The features services sub-module 630 includes output data produced by the system such as worklogs, volumes of timber handled according to worklogs, timber handling machines details, engine events and GNSS position events. The feature services sub-module can retrieve some of this data from the client feature services sub-module 642.

The real-time mobile data processing sub-module 622 performs real-time or otherwise timely processing of the data collected in the field (e.g. as reported by timber handling machinery) and received through (e.g. satellite) communication. The output of the sub-module 622 may include GNSS position events, engine events, and sensor data. This output may be stored in the database 624 and accessible to and/or via the feature services sub-module 630.

The further processing sub-module 626 operates to create the worklogs and generate contents thereof, such as volume information. This module may compute information contained in the worklogs as described above, e.g. volumes, productivities, utilization metrics, productivity influencing factors, or the like, or a combination thereof. Processing may also include the creation of volume records per day, allowing to monitor progress of each phases across the supply chain.

The web application 632 acts as an interface that allows a user to access the data produced by the system. In particular, a user is able to search for worklogs and machine information using a set of filters, display machine and worklogs information in tables and maps and visualize Harvest Supply Chain progress in tables and charts. The web application also allows an administrator to control and administrate the users access to the data. The web application may be used to generate queries, initiate computations such as predictions, and other similar tasks.

The reporting portal 634 may be used to provide data access to a larger audience. The reporting portal may be configured, e.g. automatically or by inputs of an administrator, to provide regular (e.g. weekly) and/or on-demand summaries of the utilization and productivity of the various pieces of equipment and information indicative of insight on the progress for all phases of the harvest supply chain. The web application, reporting portal, or both, can be configured to presents indications of the evolutions, over time, of volumes of timber handled at each stage in the supply chain, for example.

In some embodiments, when determining productivity of a machine, indications that an engine has been turned off (engine-off events) can be interpreted differently depending on how long the engine remains off for. For example, if an engine is turned off for less than 15 minutes, that time can be interpreted as a delay to a workflow, and the time period during which the engine is off can still be counted as productive time. If the engine is turned off for more than 15 minutes, then the time period during which the engine is off is not counted as productive time.

Additionally or alternatively, indications (e.g. from machine sensors indication operation of timber handling components) that work is being performed can be interpreted differently depending on how long the indication that the work is being performed continuously persists. For example, if a machine stops moving for one minute, that time can be interpreted as a delay to a work flow, and the time period during which the machine is not moving can still be counted as productive time. If the machine stops moving for more than 1 minute, then the time period during which the machine is not moving is not counted as productive time.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

In particular, it is within the scope of the technology to provide a computer program product or program element, or a program storage or memory device such as a magnetic, electronic or optical medium, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, or the like and pursuant to one or more, or a part of one or more, program elements, modules or objects generated from any programming language, such as C#, Java, Python, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

What is claimed is:

1. A method for timber harvesting management, comprising:
obtaining information from a timber handling machine;
determining a volume of timber handled by the timber handling machine during a specified period, wherein determining the volume comprises:
determining a path taken or an area occupied by the machine during the specified period;
determining work operations taken by the machine during the specified period;
determining a working area surrounding the path taken or the area occupied based at least in part on characteristics of the machine; and
processing the working area together with data indicative of estimated volumes of timber for a region including the working area to determine the volume of timber handled; and
generating and providing a worklog based on the obtained information, the worklog indicating the volume of timber handled.

2. The method of claim 1, wherein the worklog further indicates the working area.

3. The method of claim 1, wherein determining the working area comprises resolving an overlap between the working area and another working area determined for the machine or for another machine having a same role as the machine, the resolving including: determining an area in which the working area and the other working area overlap; keeping the area as part of one of: the working area and the other working area; and deleting the area from the other of: the working area and the other working area.

4. The method of claim 1, wherein determining the working area comprises buffering the path taken by the machine to generate an area surrounding the path, the area extending from the path to a distance which is based at least in part on a reach of the timber handling machine.

5. The method of claim 1, further comprising determining an active time of the machine, the active time indicating a time during which the engine is either turned on or the engine is turned off after being turned on, but turned on again within a predetermined threshold amount of time.

6. The method of claim 5, further comprising determining a productivity based on a ratio of the volume of timber to the active time, the worklog indicating the determined productivity.

7. The method of claim 1, wherein the estimated volumes of timber for the region are based at least in part on prior forest inventory information.

8. The method of claim 1, wherein the estimated volumes of timber for the region are based at least in part on prior timber harvesting activities performed in the region by one or more of: the timber handling machine; one or more other timber handling machines having a same role as the timber handling machine.

9. The method of claim 1, further comprising determining a role of the machine based on its location.

10. The method of claim 1, further comprising providing a plurality of worklogs including the worklog to a computerized predictor, and using the predictor to predict aspects of further timber harvesting operations based on the plurality of worklogs.

11. The method of claim 1, wherein the timber handling machine is a feller, a primary transporter, a processor or a loader.

12. A method for timber harvesting management, comprising:
for each one of a plurality of stages in a timber harvesting operation supply chain: determining an evolution, over time, of volume of timber handled at said one of the plurality of stages; and
presenting, via a user interface, a combined indication of the evolutions, over time, of said volumes of timber handled at each said one of the plurality of stages.

13. The method of claim 12, wherein the evolution of volume of timber handled is determined based on a set of worklogs, at least some of the worklogs being determined by:
obtaining information from a timber handling machine;
determining an instance of volume of timber handled by the timber handling machine during a specified period, wherein determining the instance of volume comprises:
determining a path taken or an area occupied by the timber handling machine during the specified period;
determining work operations taken by the timber handling machine during the specified period;
determining a working area surrounding the path taken or the area occupied based at least in part on characteristics of the timber handling machine; and
processing the working area together with data indicative of estimated volumes of timber for a region including the working area to determine the instance of volume of timber handled; and
generating and providing a worklog based on the obtained information, the worklog indicating the instance of volume of timber handled.

14. The method of claim 12, wherein volume of timber handled at a particular stage of the plurality of stages is determined based on a spatial analysis, the spatial analysis comprising: determining one or more working areas each surrounding a path taken or an area occupied by a corresponding timber handling machine;
processing each one of the one or more working areas together with data indicative of estimated volumes of timber for a region including said one of the one or more working areas to determine the volume of timber handled at the particular stage.

15. The method of claim 14, wherein volume of timber handled at another stage of the plurality of stages is determined based on volume or weight information reported directly by timber handling machinery performing said other stage or by timber handling machinery receiving timber from said other stage.

16. The method of claim 12, wherein the plurality of stages include two or more of: a felling stage; a primary transportation stage; a processing stage; and a loading stage.

17. The method of claim 12, further comprising automatically comparing two or more of the determined evolutions of volume of timber handled and presenting a result of said comparison.

18. A system for timber harvesting management, comprising:
a data acquisition module configured to obtain information from a timber handling machine;
a volume determination module configured to determine a volume of timber handled by the timber handling machine during a specified period, wherein the determining comprises:
determining a path taken or an area occupied by the machine during a specified period,
determining work operations taken by the machine during the specified period;
determining a working area surrounding the path taken or the area occupied, based at least in part on characteristics of the machine, and resolving overlaps between working areas; and
processing the working area together with data indicative of estimated volumes of timber for a region including the working area, to determine the volume of timber handled;
a worklog generation module configured to generate a worklog based on the obtained information, and
a user interface configured to indicate the volume of timber handled.

19. The system of claim 18, wherein the volume determination module is further configured to resolve an overlap between the working area and another working area determined for the machine or for another machine having a same role as the machine, including: determine an area in which the working area and the other working area overlap; keep the area as part of one of: the working area and the other working area; and delete the area from the other of: the working area and the other working area.

20. The system of claim 18, wherein the determining of the working area comprises buffering the path taken by the machine to generate an area surrounding the path, the area extending from the path to a distance which is based at least in part on a reach of the timber handling machine.
